(19) United States
(12) Patent Application Publication
(10) Pub. No.: US 2010/0313340 A1
(43) Pub. Date: Dec. 16, 2010

(54) PROTECTIVE CHITOSAN LAMINATES

(75) Inventors: Phong Du, Newark, DE (US); Ronald James McKinney, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/483,745

(22) Filed: Jun. 12, 2009

(51) Int. Cl. A62B 17/00; B32B 5/26; A41D 13/00; A62D 5/00

(52) U.S. Cl. 2/457; 442/239; 442/277; 442/381

(57) ABSTRACT

Provided are laminates containing in order: a fabric layer with an oil and water repellant coating, a continuous chitosan film, a continuous water vapor permeable polyurethane layer, and a fabric layer. The laminates, which have improved function in high moisture environments, can be used to make a variety of finished articles that can be used to provide protection from hazardous chemical and biological agents.

### TECHNICAL FIELD

The present invention relates to laminates prepared in part from continuous chitosan films. The laminates have improved protective properties with regard to hazardous chemical and biological agents under high moisture conditions while being sufficiently permeable to water vapor to be comfortable to wear as protective apparel.

### BACKGROUND

There is a growing need for structures that provide personal protection against toxic chemical and biological agents. It is known to devise structures that are impermeable to toxic chemical vapors and liquids, but, when used as apparel, such structures are typically also hot, heavy and uncomfortable to wear.

The degree of comfort offered by apparel worn as a protective suit is significantly affected by the amount of water vapor that can permeate through the fabric from which the suit is made. The human body continuously perspires water as a method for controlling body temperature. When a protective fabric hinders the loss of water vapor from the body, the transpirational cooling process is hindered, which leads to personal discomfort. When a protective suit allows little or no loss of water vapor, extreme heat stress or heat stroke can result in a short period of time. Hence, it is desirable that, in addition to offering the highest levels of protection against toxic chemicals and biological agents, a practical protective suit should have high water vapor transmission rates. It is also desirable that the appropriate protective structure be light in weight and offer the same high level of protection over a long period of time.

In commonly owned and co-pending U.S. Patent Publication US20050181024A1, ballistic fabric articles and protective gear comprising aramid, polybenzazole or high performance polyethylene fibers are treated with a solution containing a chitosan agent to render the articles antimicrobial, thereby preventing the development of odor, and fungal and bacterial growth. The chitosan agent can be applied to the article directly, to the fiber or as a fabric finish. Commonly owned and co-pending U.S. Patent Publication US20070196404A1 discloses laminates comprising chitosan films that are selectively permeable protective structures with respect to chemical and biological agents vs water vapor.

A need remains for improved moisture breathable laminates which can be used in articles for personal protection, which have improved performance under high moisture conditions.

### SUMMARY OF THE INVENTION

One aspect of the present invention is a laminate comprising in the following order:

a) at least one layer of fabric having an oil and water repellant treatment;

b) a continuous chitosan film;

c) at least one continuous layer of water vapor permeable polyurethane; and

d) at least one fabric layer;

wherein the oil and water repellant treatment of the fabric of (a) is oriented to the external environment when the laminate is present in an article, and wherein discontinuous adhesive is used to attach the at least one fabric layer in the laminate to the film of (a) or the polyurethane layer of (c).

Another aspect of the present invention is a finished article incorporating a laminate that comprises these layers in order and in orientation with the environment as described. Finished articles include items of apparel, shelters, and protective covers and containers.

A further aspect of the present invention is a method of inhibiting the permeation of a chemically or biologically harmful agent through an article by fabricating the article from a laminate comprising the following in order:
a) at least one layer of fabric having an oil and water repellant treatment;
b) a continuous chitosan film;
c) at least one continuous layer of water vapor permeable polyurethane; and
d) at least one fabric layer;

wherein the oil and water repellant treatment of the fabric of (a) is oriented to the external environment when the laminate is present in an article, and wherein discontinuous adhesive is used to attach the at least one fabric layer in the laminate to the film of (a) or the polyurethane layer of (c).

These and other aspects of the present invention will be apparent to one skilled in the art in view of the following description and the appended claims.

### BRIEF DESCRIPTION OF THE DRAWINGS

FIG. 1 is a schematic diagram showing the structure of a laminate according to an embodiment of the present invention.

### DETAILED DESCRIPTION

The term “film” as used herein means a thin but discrete structure that moderates the transport of species in contact with it, such as gas, vapor, aerosol, liquid and/or particulates. A film may be chemically or physically homogeneous or heterogeneous. Films are generally understood to be less than about 0.25 mm thick.

The term “sheet” or “sheeting” as used herein means a film that is at least 0.25 mm thick.

Unless otherwise stated or apparent by the particular context, the term “chitosan” as used herein includes chitosan-based moieties including chitosan, chitosan salts, and chitosan derivatives.

The term “chitosan film” as used herein means a film that contains at least one chitosan-based moiety in the amount of at least 50% by weight.

The term “nonporous” as used herein denotes a material or surface that does not allow the passage of air other than by diffusion.

The term “continuous chitosan film” as used herein means a chitosan film having at least one nonporous surface.

The term “permeable” as used herein means allowing liquids or gases to pass or diffuse through.

The term “selectively permeable” as used herein means allowing passage of certain species but acting as a barrier to others.

The term “moisture breathable” as used herein means inhibiting passage of liquid water and allowing substantial passage of water vapor.

The term “laminate” as used herein means a material comprising two or more parallel layers of material that are at least partially bonded to each other, where at least one of the layers is a fabric.

The term “substrate” as used herein means the material onto which a film is formed from solution.

The term “work device” as used herein denotes a substrate which is used only for film formation and does not subsequently become part of a laminate.

The term “soluble” as used herein denotes a material that forms a visibly transparent solution when mixed with a specified solvent. For example, a water-soluble material forms a transparent solution when mixed with water, while a water-insoluble material does not.

The term “chitosan solution” as used herein indicates that at least one chitosan moiety is dissolved in the indicated solvent. However, materials that are insoluble in the indicated solvent may also be present.

The term “(in)solubilize” as used herein means to render a material (in)soluble in a specified solvent.

The term “harmful to human health” as used herein means causing injury to humans as a consequence of acute or chronic exposure through dermal contact, ingestion, or respiration.

The term “high moisture conditions” as used herein refers to conditions with moisture levels greater than 80% relative humidity (RH) at 32° C. up to and including contact with condensed water droplets (i.e. liquid water contact).

The present invention relates to laminates prepared in part from continuous chitosan films.

In preferred embodiments, the continuous chitosan films and laminates made therefrom are substantially impermeable to certain biological and/or chemical agents. It is often desirable that the films and laminates be at least 99% impermeable to certain agents, even up to 100% impermeable.

In one embodiment, the present invention provides a protective article, fabricated from a laminate containing, in order, a fabric layer with an oil and water repellant treatment, a continuous chitosan film, a continuous water vapor permeable polyurethane layer, and a fabric layer. The laminate is held together with discontinuous adhesive. “Discontinuous adhesive” as used herein means adhesive applied in an intermittent manner that is broken up by interruptions, such as, for example, in separate drops or lines. In the article the fabric with the oil and water repellant treatment is oriented to the external environment. “Article”, as used herein includes any that may be used to protect against exposure to a chemical or biological agent that is harmful to human health including items of apparel, coverings such as sheets, tarps and tents, and storage items such as packs, food or drink storage containers and storage cases for items such as toiletries.

In other embodiments, the invention provides methods of inhibiting the permeation of a chemically or biologically harmful agent through an article by fabricating the article from a laminate containing, in order, a fabric layer with an oil and water repellant treatment, a continuous chitosan film, a continuous water vapor permeable polyurethane layer, and a fabric layer, where the oil and water repellant treatment is oriented to the external environment.

It has been found that the particular order and orientation of layers in a laminate as disclosed herein provide a protective barrier that inhibits, under high moisture conditions, permeation through the laminate of chemical and biological agents that may be harmful to humans while maintaining sufficient water vapor permeability to maintain personal comfort when the laminate is used to fabricate an item of apparel. The effectiveness of the laminate as a protective barrier under high moisture conditions makes it useful for fabrication of articles of apparel, and additional articles such as containers and coverings.

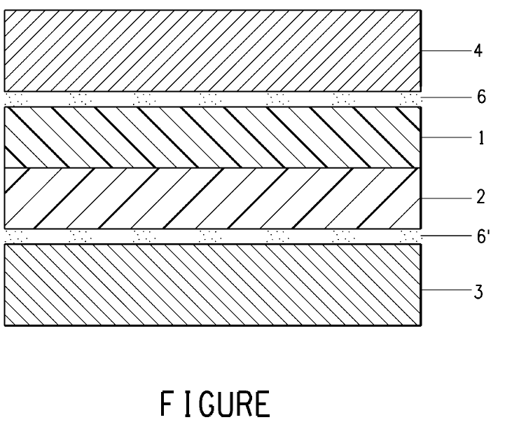

FIG. 1 illustrates one embodiment of the laminate. A laminate as shown in FIG. 1 can be used in, for example, an article of apparel. In the embodiment shown, the laminate contains the following elements: a continuous chitosan film (1); a layer of water vapor permeable polyurethane which is adhered to the chitosan film (2); an inner liner (3); an outer shell which is fabric having an oil and water repellant treatment (4); and discontinuous adhesive (6, 6′). Other embodiments of the laminates disclosed herein may contain elements additional to those shown in FIG. 1.

### Continuous Chitosan Film

The chitosan film of the laminate is a continuous chitosan film; i.e., a unitary film substantially without interruptionor break. Chitosan is a commonly used name for poly-[1-4]-β-D-glucosamine. Chitisan is commercially available and is chemically derived from chitin, which is a poly-[1-4]-β-N-acetyl-D-glucosamine that, in turn, is derived from the cell walls of fungi, the shells of insects and, especially, crustaceans. In the preparation from chitin, acetyl groups are removed, and, in the chitosan used in making the laminates disclosed herein, the degree of deacetylation is at least about 60%, and is preferably at least about 85%. As the degree of deacetylation increases, it becomes easier to dissolve chitosan in acidic media.

“Chitosan”, as used herein with regard to the chitosan film, unless stated otherwise or apparent from context, includes chitosan-based moieties that are suitable for making chitosan films. Thus, the chitosan film can be made using chitosan and/or chitosan-based moieties. Suitable chitosan-based moieties include chitosan, chitosan salts, and chitosan derivatives. Representative examples of chitosan derivatives suitable for use in the laminates disclosed herein include N— and O-carboxyalkyl chitosan. The number average molecular weight (Mₙ) in aqueous solution of the chitosan preferably at least about 10,000.

A chitosan film can be cast from solution. If it is desired to cast a chitosan film from an aqueous solution, the chitosan is first solubilized, since chitosan is not soluble in water. Preferably, solubility is obtained by adding the chitosan to a dilute solution of a water-soluble acid. This allows the chitosan to react with the acid to form a water-soluble salt, herein referred to as a “chitosan salt” or “chitosan as the (acid anion) thereof”, for example “chitosan as the acetate thereof” if acetic acid was used. Chitosan derivatives such as N— and O-carboxyalkyl chitosan that are water-soluble can be used directly in water without the addition of acid.

The acid used to solubilize the chitosan may be inorganic or organic. Examples of suitable inorganic acids include hydrochloric acid, sulfamic acid, warm to hot sulfuric acid, phosphoric acid and nitric acid. Suitable organic acids include water-soluble mono-, di- and polycarboxylic acids such as, for example, formic acid, acetic acid, pimellic acid, adipic acid, o-phthalic acid, levulinic acid, glyoxylic acid and halogenated organic acids. Other suitable acids are disclosed in U.S. Pat. No. 2,040,880. Mixtures of acids may also be used. Volatile acids, that is, those with a boiling point less than about 200° C., are preferred.

The amount of acid used to solubilize the chitosan can be chosen to control the viscosity. If too little acid is added, the resulting solution may be too viscous to cast a thin film and/or to be filtered. The desired amount of acid used will also depend on the desired chitosan concentration in the solution, and on the molecular weight and degree of deacetylation of the starting chitosan, since those properties determine the molar concentration of amino groups (—NH₂) available to react with the acid. Typically the weight ratio of chitosan to acid is from about 2.68:1 to 1:1.

The appropriate concentration of chitosan in the solution will vary depending on how the solution is to be applied, and also on the molecular weight of the chitosan, as a lower concentration may be desired for a relatively high molecular weight chitosan. Different application methods may work better with solutions of different viscosities, but typically, the solution will contain from about 0.1 to about 15 wt % chitosan, based on the total combined weight of the solution and the chitosan.

The chitosan solution from which the film is prepared can include a release aid to aid in removal of the chitosan film from a substrate on which it is cast. The release aid is typically polar enough to be easily dispersed in aqueous solution and preferably does not alter physical properties of the chitosan film. The release aid may be a surfactant. In some embodiments, the release aid is the quaternary ammonium salt tricaprylylmethylammonium chloride; trioctylmethylammonium chloride (CAS#63393-96-4), which may be purchased as Aliquat® 336 from Aldrich Chemical Company (Milwaukee, Wis.).

The chitosan solution from which the film is prepared can include organic polymers, including natural polymers such as starch or cellulose, and synthetic polymers such as polyurethanes, polyamides, and polyesters. Such polymers may be soluble or insoluble in the chitosan solution. For example, a polyamide can be dissolved in a solution of chitosan and formic acid, while a polyurethane suspension in water would remain a suspension when added to a chitosan/acetic acid solution.

The chitosan solution from which the film is prepared can include inorganic fillers, including without limitation, glass spheres, glass bubbles, clays (e.g., sepiolite, attapulgite, and montmorillonite) and the like. Small amounts of such fillers, preferably less than 10 wt %, can be used to increase thermal stability, modulus, and barrier properties of the chitosan film where desirable.

The chitosan solution from which the film is prepared can include additives such as flame retardants, plasticizers, stabilizers, tougheners, to enhance various properties of the chitosan film such as strength, flexibility, fire resistance and dimensional stability. For example, flexibility of the film when wet can be enhanced by addition of ketoacids such as glyoxylic acid and levulinic acid, which react with chitosan to form N-(carboxymethylidene) chitosans. N-(carboxymethylidene) chitosans can be insolubilized by heat-treating and are physically flexible in the presence of moisture. In other examples, film insolubility can be obtained by adding sugars such as glucose and fructose to the chitosan solution. Additives to a chitosan solution may be soluble in the solution, or they may be present as dispersed insoluble material. Adding sugars and di- or multi-functional acids can reduce the thermal requirements for rendering the chitosan insoluble. With the use of additives additives, annealing temperatures of about 100° C. -120° C. for about 1 to 10 minutes cause insolubility. The additives are present at less than 50% by weight, based on the total combined weight of chitosan plus additives. The chitosan film contains at least 50% chitosan by weight. More particularly, the chitosan film can contain about 50%-55%, 55%-60%, 60%-65%, 65%-70%, 70%-75%, 75%-80%, 80%-85%, 85%-90%, 90%-95%, or greater than 95% chitosan by weight.

A chitosan film can be prepared by casting a chitosan solution directly onto a substrate of water vapor transmissible polyurethane that will be incorporated along with the film into the present laminate. Alternatively, the chitosan solution can be cast onto a substrate that is a work device such as a smooth surface, such as glass or a polymer film (for example, polyester film). If the film is cast onto a work device, the film is then dried, detached and then incorporated into the laminate in a separate step. Alternatively, the film can be cast onto a work device and then a layer of water vapor transmissible polyurethane can be cast onto the chitosan film. Then both the chitosan film and polyurethane layer are detached and incorporated into the laminate.

The solution can be applied to a substrate by any of a variety of methods known in the art. For a small scale process, such as a laboratory test sample, the solution is typically applied using a doctor knife. Methods available to coat surfaces that are planar and have irregular surfaces include spray coating, dip coating, and spin coating. In a commercial process, the solution can be applied to, e.g., a traveling web using methods such as, for example, reverse roll, wire-wound or Mayer rod, direct and offset gravure, slot die, blade, hot melt, curtain, knife over roll, extrusion, air knife, spray, rotary screen, multilayer slide, coextrusion, meniscus, comma and microgravure coating. These and other suitable methods are described by Cohen and Gutoff in “Coating Processes” in the Kirk-Othmer Encyclopedia of Chemical Technology [John Wiley & Sons, 5^{th} edition (2004), Volume 7, Pages 1-35]. The method chosen will depend on several factors, such as the rheology of the solution to be applied, the desired wet film thickness, the speed of a substrate that is traveling, and the required coating accuracy as a percent of total thickness.

The applied solution is then dried by any suitable method known in the art such as exposure to a hot air oven, air impingement drying, or radiative (e.g. infrared or microwave) drying (Cohen and Gutoff, op. cit.). The result of the drying at this stage is a continuous film. If the chitosan is dissolved in an aqueous solution of a volatile acid, that is, an acid whose boiling point is less than about 200° C., exposure to ambient air may be sufficient for drying, and drying will remove acid as well as water. Some typical methods for drying include maintaining at room temperature for about 18 hours, and passing through a 3-zone oven with equal zones at 70° C., 70° C. and 130° C. for about 1.5 minutes in each zone. Passing through a 3-zone oven with equal zones at 70° C., 100° C. and 160° C. for about 1.5 minutes in each zone will also dry and anneal the film.

If a film at this stage is water-soluble, it can be made water-insoluble by heating; by reacting it with a crosslinking reagent; by treatment with a strong base; or by a combination of two or more of these methods. For example, a film cast from a formic acid solution can be made water-insoluble by heat treatment after the film has been formed and dried, for example, by heating at between about 100° and about 260° C. for about 0.1 to about 60 minutes, or more preferably between about 100° C. and 180° C. for about 1 to 10 minutes. The drying time and temperature are inversely correlated, with shorter times used for higher temperatures. Heat treatment plus the use of a crosslinking agent may also be used to render the chitosan film insoluble.

The film can also be made insoluble by adding a crosslinking agent to the solution before a film is cast therefrom. A crosslinking agent is a reactive additive that creates bonds, i.e. crosslinks, between polymer chains. Examples of crosslinking agents for chitosan include glutaraldehyde and di-, and tri-carboxylic acids including succinic, malic, tartaric, and citric acids. Crosslinking agents may also be applied to the film after it is dried.

The film can also be made water-insoluble by contacting the film with a base and then washing, which converts the film from the chitosan salt form to free chitosan. If the film to be treated with base is attached to a substrate, the composition and concentration of the base will be influenced by the nature of the substrate (e.g., its reactivity toward base) and processing conditions (e.g., temperature and contact time, continuous versus batch process). Typically, the base is a 1% to 10% by weight aqueous solution of sodium hydroxide, and typical contact times are 30 seconds to 3 hours at ambient temperature. Heat treatment plus contact with base could also be used to render the film insoluble.

### Water Vapor Permeable Polyurethane

The water vapor permeable polyurethane can be any polyurethane that has properties of water vapor transmission suitable for the intended purpose of the laminate or article fabricated from the laminate. Any continuous polyurethane layer with a Moisture Vapor Transport Rate (MVTR) of at least about 2 kg m²/24 h can be used to prepare a laminate having a MVTR of at least about 2 kg m²/24 h. The MVTR is measured, for purposes of this disclosure, as described herein in General Methods and may differ from rates determined using the ASTM E-96B (50% RH, 23° C.) protocol that is often reported for commercial materials. For example, polyurethanes with water vapor transmission rates in the range of about 0.2 kg/cm²/24 h to 0.4 kg/cm²/24 h as measured by the ASTM E-96B (50% RH, 23° C.) protocol are useful in the present laminates to be used for fabrication of articles that are coverings, such as tarps, and containers, such as for food or toiletries. For example, polyurethanes with water vapor transmission rates in the range of about 0.5 kg/cm²/24 h to 0.7 kg/cm²/24 h as measured by the ASTM E-96B (50% RH, 23° C.) protocol are useful in the laminates intended for fabrication of articles of apparel. Water vapor permeable polyurethanes that can be used in the laminates include those available from Lubrizol (Cleveland, Ohio) as Estane® 58315, Estane® 75AT3, Estane® 58237, and Estane® 58245, which have reported ASTM E-96B measured water vapor transmission rates of 0.250, 0.380, 0.550, and 0.650 kg/cm²/24 h, respectively. However the measured MVTR can vary depending on the thickness of a polyurethane layer. For example, a polyurethane layer can be made as a thinner layer than that used in the commercial material testing, giving a higher rate of moisture vapor transmission.

At least one layer of water vapor permeable polyurethane is included in the laminate as a continuous layer, located on the side of the chitosan layer that is opposite to the exterior environment (i.e. internal when in a fabricated article. It has been found that placing the water vapor permeable polyurethane layer internal to the chitosan film greatly improved the protective property of the laminate under high moisture conditions, as compared to a laminate with the polyurethane layer placed externally to the chitosan film. With the water vapor permeable polyurethane layer internal to the chitosan film, the laminate is substantially as effective under high moisture conditions as under low moisture conditions in the external environment.

The water vapor permeable polyurethane can be cast from a solution onto a prepared chitosan film, and the polyurethane and chitosan film layers together incorporated into the present laminate. Alternatively, a water vapor permeable polyurethane layer can be cast followed by casting a chitosan solution to form a chitosan film on the polyurethane. The latter method can be used particularly when the water vapor permeable polyurethane forms a smooth layer, i.e., substantially without protrusions above the plane of the substrate that are higher than the desired thickness of the coating of chitosan that will be transformed into the film. Another method is to cast the chitosan film and water vapor permeable polyurethane layer separately, and incorporate both into the laminate adjacent to each other and oriented as described. Typically the chitosan film is cast first, then the water vapor permeable polyurethane layer is cast on the chitosan film providing good contact between the two materials.

### Fabric Layers

There is at least one fabric layer on each of the chitosan film side and the water vapor permeable polyurethane layer side in the laminate. Typically in an article fabricated from the laminate the layers include an outer layer of fabric with an oil and water repellant treatment (an outer shell: 4 in FIG. 1), which is exposed to the environment, and an inner liner (3 in FIG. 1). The outermost fabric layer on the chitosan film side of the laminate has an oil and water repellant treatment. The outer and inner fabrics can be independently chosen for functional reasons such as ruggedness, ballistic resistance, and resistance to abrasion or tearing, as well as to impart a comfortable feel and a fashionable appearance to apparel. Colored and patterned materials can also be used as outer layers to introduce camouflage features in military applications.

Fabrics used in the fabric layer can be wovens or nonwovens (e.g., nonwoven sheet structures created by spun bonded/melt blown processes or by electrospinning as described in, e.g., Z. -M. Huang et al., Composites Science and Technology (2003), 63, 2223-2253). The fabrics can be prepared from any synthetic or natural fiber appropriate for a particular end use. Preferred fabrics can be prepared from aramids, nylons, polyesters, cotton, and blends comprising any of these, such as, for example, blends of nylon and cotton fibers (“NYCO”). The term “nylon” as used herein refers to polyamides other than aramids. An aramid is an aromatic polyamide, wherein at least 85% of the amide (—CONH—) linkages are attached directly to two aromatic rings. Flame retardant fibers, including aramids (preferably up to 40%) canbe blended with an aramid to impact fabric thermal performance and comfort. A suitable aramid can be in the form of a copolymer that can have as much as 10 percent of other diamine(s) substituted for the diamine of the aramid or as much as 10 percent of other diacid chloride(s) substituted for the diacid chloride of the aramid. A p-aramid is generally preferred in a fabric for use in the laminates, and poly(p-phenylene terephthalamide) (PPD-T) is a preferred p-aramid. M-aramids can be used, and poly (m-phenylene isophthalamide) (MPD-I) is a preferred m-aramid. P-aramid and m-aramid fibers and yarns particularly suitable for use in the laminates include those sold respectively under the trademarks Kevlarl and Nomex® (E. I. du Pont de Nemours and Company, Wilmington Del., USA), and Teijinconex®, Twaron® and Technora® (Teijin Ltd., Osaka, Japan), and equivalent products offered by others. Typically, the aramid fabric is used in the outer shell, and the inner liner can contain fabric such as polyester, nylon, cotton, or blends thereof, although m-aramids can also be used as part of the inner liner, to improve fire resistance.

The outer fabric layer of the laminate has an oil and water repellant treatment applied to the fabric. “Treatment” as used herein in this context means a composition applied to the laminate, rather than a particular process. Any durable discontinuous oil and water repellant treatment that provides a liquid water barrier yet is permeable to water vapor can be used. The treatment covers and partially penetrates the bundles of fibers of the fabric, thereby retaining breathability and porosity of the fabric. Typically, oil and water repellent treatments include fluorosurfactants. The treatment compositions are based on fluorinated polymer compounds with a perfluorinated aliphatic group such as those disclosed in U.S. Pat. No. 5,276,175 and EP435641, or with perfluorinated ether moieties as disclosed in EP1038 919, EP273449, U.S. Pat. No. 3,536,710, U.S. Pat. No. 3,814,741, U.S. Pat. No. 3,553,179 and U.S. Pat. No. 3,446,761, or a fluorinated polyether compound as disclosed in U.S. Pat. No. 7,425,279B2. Common brands of repellant treatment include ReviveX®, Scotchgard™, Tectron, and Granger's. An example of a repellant treatment is a mixture of Zonyl® 7040, Hydrophobal XAN, and Alkanol 6112.

A repellant treatment can be applied by known methods known such as dipping, spraying, soaking, sponge coating, blade coating, rod coating, and nip coating. Fabrics with oil and water repellent coatings that can be used are commercially available such as Gore-Tex® (W. L. Gore & Associates), PreCip® (Marmot), H2No® (Patagonia), Omni-Tech® (Columbia Sportswear), and HyVent® (North Face). The repellent coating treatment is generally cured thermally, resulting in a durable coating.

### Additional Layers

Additional layers, such as one or more additional fabric layers or a microporous membrane, can be used for some applications. Additional layers may provide additional features to the laminate, for example, including ballistic fabrics can be used to absorb the impact of a projectile and protect the wearer from harm.

Films and microporous membranes that may be included may be prepared from any synthetic or natural material appropriate for the specific end use in mind. Examples of films and microporous membranes that can be used as a component of inner liners or outer shells include without limitation expanded poly(tetrafluoroethylene) membranes such as those sold under the trademark GORE-TEX® (W. L. Gore & Associates, Inc., Newark, Del., USA); hydrophobic polyurethane microporous membranes (as disclosed, for example, in S. Brzezinski et al., Fibres & Textiles in Eastern Europe, January/December 2005, 13(6), 53-58); microporous (poly)propylene available from, e.g., 3M (St. Paul, Minn., USA); thin films of thermoplastic polyurethane such as those sold under the trademark Transport® Brand Film by Omniflex (Greenfield, Mass., USA); Pebax® polyether block amide by Arkema (Paris, France); and DuPont™ Active Layer, a polyester film available from E. I. du Pont de Nemours and Company (Wilmington, Del., USA).

### Fabrication

The laminates disclosed herein can be assembled using any known sewing, stitching, stapling or adhering operations, including thermally pressing.

Referring to FIG. 1, layers to be assembled include the continuous chitosan film (1); a continuous layer of water vapor permeable polyurethane (2); an inner liner (3); an outer shell (4). For example, if the chitosan film is cast on a work device, the film is then dried and detached as a free-standing film. The water vapor permeable polyurethane layer may be typically added before detachment from the work device. Or the water vapor permeable polyurethane may be cast on a work device and used as a substrate for the chitosan film to be cast thereon. The chitosan film and/or polyurethane layer may then be attached to an outer shell and/or inner liner, respectively, using an adhesive. A discontinuous adhesive is used to attach at least one fabric layer in the laminate to the chitosan film or the polyurethane layer. Any discontinuous adhesive that holds a fabric layer to the chitosan film or to the polyurethane layer may be used, such as a polyurethane-based adhesive. The adhesive is present as a discontinuous layer such as an array of adhesive dots, or in a number of alternative patterns such as lines or curves. Preferably, dots are used to provide a discontinuous layer of adhesive, in order not to block passage of gases and/or liquids through the laminate. The discontinuous adhesive may be applied in a variety of ways including spraying or gravure roll, and may be thermally bonded.

To fabricate an article from a laminate disclosed herein, such as an item of apparel, the laminate can be sandwiched between additional woven fabrics. The laminate and the additional fabrics are discontinuously attached to each other. Discontinuous attachment can be achieved, for example, with adhesive dots. Alternative methods of attachment include sewing the edges together, an arrangement often referred to as a “hung liner”, hook-and-loop attachment, stapling and zippers. In some applications, discontinuous attachment is achieved by attaching the layers to each other partially or completely around their edges.

### Uses

The present laminate is moisture breathable. It is preferred that the present laminate have a Moisture Vapor Transport Rate (“MVTR”) of at least 2 kg m²/24 h, as measured herein using the process described in General Methods, while the transport rate of materials harmful to human health is low enough to prevent the occurrence of injury, illness or death. It is highly preferred that the MVTR and transport rate properties are maintained in a high moisture environment. The desired transport rate is termined by the harmful material(s) against which protection is desired.; For example, NFPA 1994, 2006 Revision requires <20 μg/cm² for 24 hours cumulative permeation for sulfur mustard (S(CH₂CH₂Cl)₂). Consequently, the laminates can be used for the fabrication of, or as a component in, a variety of articles of manufacture, including articles of protective apparel, especially for clothing, garments or other items intended to protect the wearer or user against harm or injury as caused by exposure to toxic chemical and/or biological agents, including those agents potentially used in a warfighter environment and materials identified as “Toxic Industrial Chemicals” (TICs) or “Toxic Industrial Materials” (TIMs) in, for example, Guide for the Selection of Chemical and Biological Decontamination Equipment for Emergency First Responders, NIJ Guide 103-00, Volume I, published by the National Institute of Justice, U.S. Department of Justice (October 2001). Examples of TICs are phosgene, chlorine, parathion, and acrylonitrile. Permeability of the laminate or a layer in the laminate to specific substances can be determined by various methods such as, for example, those described in ASTM F739-91, “Standard Test Method for Resistance of Protective Clothing Materials to Permeation by Liquids or Gases Under Conditions of Continuous Contact.”

In one embodiment, the item of apparel is useful to protect military personnel against dermal exposure to chemical and/or biological agents potentially encountered in a warfighter environment. Examples of such agents include nerve agents such as Sarin (“GB,” O-isopropyl methylphosphonofluoridate), Soman (“GD,” O-Pinacolyl methylphosphonofluoridate), Tabun (“GA,” O-Ethyl N,N-dimethylphosphoramidocyanidate), and VX (O-Ethyl S-2-diisopropylaminoethyl methylphosphonothiolate); vesicant agents such as sulfur mustards (e.g., Bis(2-chloroethyl)sulfide and Bis(2-chloroethylthio)methane); Lewisites such as 2-chlorovinyldichloroarsine; nitrogen mustards such as Bis-(2-chloroethyl) ethylamine (“HN1”); tear gases and riot control agents such as Bromobenzyl cyanide (“CA”) and Phenylacyl chloride (“CN”); human pathogens such as viruses (e.g., encephalitis viruses, Ebola virus), bacteria (e.g., Rickettsia rickettsii, Bacillus anthracis, Clostridium botulinum), and biological toxins (e.g., Ricin, Cholera toxins). A human pathogen, as used herein, is any microorganism that causes disease in humans.

In a further embodiment, the item of apparel is used to protect first responder personnel from known or unknown chemical or biological agents potentially encountered in an emergency response situation. In yet another embodiment, the item of apparel is used to protect cleanup personnel from chemical or biological agents during a hazmat response situation. Examples of hazardous materials against which such items of apparel can provide protection include, in addition to those recited hereinabove, pesticides, particularly organophosphate pesticides.

Such clothing, garments or other items include coveralls, protective suits, coats, jackets, limited-use protective garments, raingear, ski pants, gloves, socks, boots, shoe and boot covers, trousers, hoods, hats, masks and shirts.

In another embodiment, the laminates can be used to create a protective cover, such as a tarpaulin, or a collective shelter, such as a tent, to protect against chemical and/or biological warfare agents.

In yet another embodiment, the laminates can be used to create a protective laminate storage container, such as for food, drink, or toiletries, to protect against chemical and/or biological warfare agents, and in medical applications. The food, drink, or toiletries can be in an internal wrapping or container, such as in plastic wrap or a box, that is inside the protective laminate storage container, such as a pack, satchel, or box.

Furthermore, the laminates can be used in various medical applications as protection against toxic chemical and/or biological agents. In one embodiment, the laminates can be used to construct items of apparel for health care workers, such as medical or surgical gowns, gloves, slippers, shoe or boot covers, and head coverings.

### EXAMPLES

Specific embodiments of the present invention are illustrated in the following examples. The embodiments of the invention on which these examples are based are illustrative only, and do not limit the scope of the appended claims.

The meaning of the abbreviations used in the examples is as follows: “s” means second(s), “min” means minute(s), “h” means hour(s), “kg” means kilogram(s), “g” means gram(s), “mg” means milligram(s), “μg” means microgram(s), “oz” means ounce(s), “yd” means yard(s), “mmol” means millimole(s), “m” means meter(s), “cm” means centimeter(s), “mm” means millimeter(s), “μm” means micrometer(s), “mL” means milliliter(s), “μL” means microliter(s), “M” means molar, “N” means normal, “wt %” means weight percent, “ppm” means parts per million, “MW” means molecular weight, “Mₙ” means number average molecular weight, “M_{w}” means weight average molecular weight, “ND” means not detected, “Pa” means Pascal, “kPa” means kilopascal, “psig” means pounds per square inch gage, “PU” means polyurethane, and “SEC” means size exclusion chromatography. Unless otherwise specified, the water used is distilled or deionized water.

The chitosan materials used in the following Examples were obtained from Aldrich Chemical Company (Milwaukee, Wis., USA), or Primex Ingredients ASA, Norway under the trademark ChitoClear® chitosan, as noted. According to the manufacturer, Primex ChitoClear® TM-656 has a Brookfield viscosity of 26 cP (0.026 Pa·s, 1% chitosan in a 1% aqueous acetic acid solution). The Mn and Mw were determined by SEC to be 33,000 and 78,000, respectively.

### General Methods

### Standard Glass Plate and Mylar Preparation

When films are to be cast onto a work device such as a glass plate, it is important that the glass plate surface be clean. The following cleaning procedure was used for the examples, but any thorough cleaning procedure would be suitable. A Pyrex® glass plate is washed with PEX lab soap, rinsed with water, and wiped dry. The plate is then cleaned with methanol and, finally, coated and rubbed with 10 wt % aqueous NaOH solution and allowed to stand for ten minutes. The plate is ready for casting after a final rinse with water and drying with soft paper towels. When working with a sheet of mylar as the work device, similar thoroughness to cleaning is required. The mylar surface is wiped with a dry, soft paper towel to remove macroscopic debris before cleaning with methanol. Afterwards, the mylar is inspected to make sure there is no debris that can interrupt the casting process and introduce defects.

### Moisture Vapor Transmission Rate (MVTR)

MVTR is measured by a method derived from the Inverted Cup method of MVTR measurement [ASTM E 96 Procedure BW, Standard Test Methods for Water Vapor Transmission of Fabrics (ASTM 1999)]. A vessel with an opening on top is charged with water and then the opening is covered first with a moisture vapor permeable (liquid impermeable) layer of expanded-PTFE film (“ePTFE”), and then with the laminate sample for which the MVTR is to be measured. The layers are sealed in place, inverted for 30 minutes to condition the layers, weighed to the nearest 0.001 g, and then contacted with a dry stream of nitrogen while inverted. After the specified time, the sample is re-weighed and the MVTR calculated (kg m²/24 h) by means of the following equation:

MVTR=1/[(1/MVTR_{obs}.)−(1/MVTR_{mb})]

where MVTR_{obs} is observed MVTR of the experiment and MVTR_{mb} is the MVTR of the ePTFE moisture barrier (measured separately). The reported values are the average of results from four replicate samples.

### Dimethylmethyliphosphonate (“DMMP”) Permeation

DMMP is used as a relatively non-toxic simulant for chemical warfare G-class nerve agents. The DMMP permeation for the examples described below was carried out as follows: a vessel with an opening on top was charged with a measured amount of water containing 0.100% propylene glycol as an internal GC standard. If the sample was a film, the opening was covered with the sample film and a woven fabric overlayer [NYCO 50:50 nylon/cotton blend, 6.7 oz/yd² (0.23 kg m²) or Nomex®, 5.6 oz/yd² (0.19 kg m²), both treated with durable water repellant finish] was placed on top of the film, and the layers were sealed in place. If the sample was a laminate that already had a fabric surface, no additional fabric overlayer was used. In both types of samples, the fabric surface was treated with one 2 μL drop of DMMP (2.3 mg). The vessel was placed in a nitrogen-purged box for 17 h and then the DMMP concentration in the water was measured by GC analysis. Results are reported in μg of DMMP measured in the water after 17 h and are the average of five replicate samples. The DMMP was obtained from Aldrich Chemical Company (Milwaukee, Wis.) and was used as received.

A version of this test, known as the wet towel test, included a wet towel insert below the sample (i.e. between the sample and vessel opening) to provide liquid water to the sample during testing. A Sontara® SPS towel was saturated with water and then the excess was squeezed out before insertion below the laminate or NYCO layer. The remaining protocol for the testing process remained the same.

### Sulfur Mustard Transmission Rates.

The military TOP-8-2-501 (dual flow method) was used to test 24 hour permeation against sulfur mustard, S(CH₂CH₂Cl)₂ (HD). This test is usually performed at 80% RH, but we requested higher humidity testing at 90% RH.

### Preparation of Chitosan Solution

This method was used to prepare chitosan solutions for the examples unless otherwise noted. A bottle filled with 581 g of distilled water and 31.2 g of Primex ChitoClear® TM-656 chitosan was heated in a water bath at 80° C. and vigorously mixed with an overhead stirrer for 10 minutes. A syringe was used to add 11.6 g of glacial acetic acid (Sigma-Aldrich) to the solution which was mixed for an additional 10 minutes. The bottle was then removed from the water bath and allowed to cool to room temperature before filtration under vacuum with a coarse fritted filter. The solution was allowed to sit for at least 18 hours for bubbles to settle out. This recipe generated a 5% aqueous chitosan solution.

### Standard Estane® Solution Preparation

This method was used to prepare Estane® solutions for the examples unless otherwise noted. A flask was filled with 93 g of THF and heated in an 80° C. water bath before the batch addition of 7 g of Estane® 58237 pellets (Lubrizol). The solution was stirred until the pellets dissolved and then removed from the water bath and allowed to cool before use. This recipe generated a 7% Estane® solution in THF.

### Example 1

An aqueous solution of 5 wt % chitosan was cast with a 20 mil (0.508 mm) metering knife onto a 3 mil (0.076 mm) Mylar® polyester film and placed in a heated oven (100° C.) to dry the chitosan film for 30 minutes. A water permeable polyurethane Estane® 58237 (Lubrizol, Wickliffe, Ohio) in tetrahydrofuran (7 wt % solution) was cast with a 10 mil (0.254 mm) metering knife onto the chitosan film and this second layer was allowed to air dry. The resulting bilayer film consisting of the chitosan film and the Estane® 58237 layer was then removed from the polyester substrate by raising the edges of the film from the polyester substrate with a razor blade, then pulling the film cautiously from the polyester substrate, and placed in a 160° C. oven for 4 minutes to remove any residual solvent and to insolubilize the chitosan layer. The chitosan layer was nominally 15 μm thick and the Estane® layer was nominally 5 μm thick.

A universal Nomex® camo woven fabric (5.6 oz/yd², 190 g/m²) was given an oil and water repellant treatment. The treatment solution consisted of 738 g water, 200 g Zonyl® 7040, 60 g Hydrophobal XAN, and 2 g Alkanol 6112. This solution was sprayed onto the fabric to provide the outer shell of the laminate, and then dried and cured at 160° C. for 4 minutes.

The treated fabric was attached to the chitosan side of the bilayer with hot melt adhesive with a press at 5 PSI and 110° C. for 10 seconds. A jersey knit Nomex® fabric (1.3 oz/yd², 44 g/m²) was attached to the Estane® side of the bilayer with hot melt adhesive with a press at 5 PSI and 110° C. for 10 seconds (see FIG. 1). The resulting laminate was tested for MVTR, DMMP in dry and wet conditions, and sulfur mustard transmission as described in General Methods. The results are given in Table 1 below.

### Comparative Examples

The following examples demonstrate the fabrication of samples with lower effectiveness under wet conditions.

### Comparative Example A

A chitosan/Estane® 58237 bilayer film was constructed per the instructions from Example 1. A universal Nomex® camo woven fabric (5.6 oz/yd², 190 g/m²) without the durable water repellant finish was attached to the chitosan side of the bilayer with hot melt adhesive with a press at 5 PSI and 110° C. for 10 seconds. A jersey knit Nomex® fabric (1.3 oz/yd², 44 g/m²) was attached to the Estane® side of the bilayer with hot melt adhesive with a press at 5 PSI and 110° C. for 10 seconds. This laminate differed from that in Example 1 only in the lack of the durable water repellant finish on the camo woven fabric. The resulting laminate was tested for DMMP in dry and wet conditions and sulfur mustard transmission as described in General Methods. The results are given in Table 1 below.

### Comparative Example B

A chitosan/Estane® 58237 bilayer film was constructed per the instructions from Example 1. A universal Nomex® camo woven fabric (5.6 oz/yd², 190 g/m²) treated with a durable water repellant finish, as described in Example 1, was attached to the Estane® side of the bilayer with hot melt adhesive with a press at 5 PSI and 110° C. for 10 seconds. A jersey knit Nomex® fabric (1.3 oz/yd², 44 g/m²) was attached to the chitosan side of the bilayer with hot melt adhesive with a press at 5 PSI and 110° C. for 10 seconds. This laminate differed from that in Example 1 only in the inverted orientation of the bilayer film with respect to the fabric layers. The resulting laminate was tested for MVTR, and DMMP in dry and wet conditions as described in General Methods. The results are given in Table 1 below.

### Comparative Example C

A chitosan/Estane® 58237 bilayer film was constructed per the instructions from Example 1. A universal Nomex® camo woven fabric (5.6 oz/yd², 190 g/m²) without a durable water repellant treatment was attached to the Estane® side of the bilayer with hot melt adhesive with a press at 5 PSI and 110° C. for 10 seconds. A jersey knit Nomex® fabric (1.3 oz/yd², 44 g/m²) was attached to the chitosan side of the bilayer with hot melt adhesive with a press at 5 PSI and 110° C. for 10 seconds. This laminate differed from that in Example 1 both in its lack of a durable water repellant treatment and in the inverted orientation of the bilayer film with respect to the fabric layers. The resulting laminate was tested for DMMP in dry and wet conditions as described in General Methods. The results are given in Table 1 below.

Error! Reference source not found. Performance of different laminates

| | DMMP | DMMP | HD | |
|---|---|---|---|---|
| | wet towel | dry | 90% RH | MVTR |
| Sample | μg//cm²/17 h | μg/cm²/17 h | μg/cm²/24 h | kg/m²/day |
| Example 1 | 29 | 1 | 7 | 7.4 |
| Comparative A | 135 | 0 | 81 | *nt |
| Comparative B | 226 | 19 | nt | 7 |
| Comparative C | 659 | 15 | nt | nt |

*nt: not tested

What is claimed is:

1. A laminate comprising in the following order:
a) at least one layer of fabric having an oil and water repellant treatment
b) a continuous chitosan film;
c) at least one continuous layer of water vapor permeable polyurethane; and
d) at least one fabric layer;
wherein the oil and water repellant coating of the fabric of (a) is oriented to the external environment when the laminate is present in an article, and wherein discontinuous adhesive is used to attach at least one fabric layer in the laminate to the film of (a) or the polyurethane layer of (c).

2. The laminate according to claim 1 wherein the polyurethane of (c) has a water vapor transmission rate of at least about 2 kg m²/24 h.

3. The laminate according to claim 1 wherein the oil and water repellant treatment of the fabric of (a) comprises a fluorosurfactant.

4. The laminate according to claim 1 wherein the chitosan film further comprises one or more members selected from the group consisting of natural polymers, synthetic polymers, crosslinking agents, fillers, flame retardants, plasticizers, tougheners, and stabilizers, and wherein the film comprises at least about 50% chitosan by weight.

5. The laminate according to claim 1 wherein each of the fabric of (a) and the fabric of (d) are independently woven or nonwoven fabric.

6. The laminate according to claim 5 wherein the woven or nonwoven fabric comprises one or more members selected from the group consisting of aramid, polybenzimidazole, nylon, and cotton.

7. The laminate according to claim 1 having a Moisture Vapor Transmission Rate of at least about 2 kg m²/24 h and being at least about 99% impermeable to at least one chemical or biological agent harmful to human health.

8. The laminate according to claim 7 wherein the chemical or biological agent is selected from the group consisting of nerve agents, vesicant agents, Lewisites, nitrogen mustards, tear gases, riot control agents, toxic industrial chemicals, pesticides; phosgene, chlorine, parathion, acrylonitrile; and viruses, bacteria, and biological toxins.

9. The laminate according claim 1 further comprising at least one additional layer.

10. A finished article incorporating the laminate of claim 1.

11. The finished article according to claim 10 wherein said article is selected from the group consisting of items of apparel, shelters, and protective covers.

12. An item of apparel according to claim 11 wherein the item of apparel is selected from the group consisting of coveralls, protective suits, coast, jackets, limited-use protective garments, raingear, ski pants, gloves, socks, boots, shoe or boot covers, trousers, hoods, hats, masks, shirts and medical garments.

13. A medical garment according to claim 12 wherein the medical garment is selected from the group consisting of medical or surgical gowns, gloves, slippers, shoe or boot covers, and head coverings.

14. A method of inhibiting the permeation of a chemically or biologically harmful agent through a laminate, or a structure or item of apparel fabricated therefrom, by including within the laminate the following in order:
a) at least one layer of fabric having an oil and water repellant treatment;
b) a continuous chitosan film;
c) at least one continuous layer of water vapor permeable polyurethane; and
d) at least one fabric layer;
wherein the oil and water repellant treatment of the fabric of (a) is oriented to the external environment when the laminate is present in an article, wherein discontinuous adhesive is used to attach the at least one fabric layer in the laminate, and wherein the laminate is substantially as effective for protection against at least one chemical or biological agent harmful to human health under high moisture conditions as under low moisture conditions in the external environment.

15. The method of claim 14 wherein said method provides protection of military personnel against dermal exposure to chemical and biological agents potentially encountered in a warfare environment; protection of first responder personnel from chemical or biological agents in an emergency response situation; or protection of cleanup personnel from chemical or biological agents during a hazmat response situation.
